(19) United States
(12) Patent Application Publication
(10) Pub. No.: US 2024/0373232 A1
(43) Pub. Date: Nov. 7, 2024

(54) METHOD OF ANNOTATING MAP DATA FOR NAVIGATION OF VEHICLES

(71) Applicant: GRABTAXI HOLDINGS PTE. LTD., Singapore (SG)

(72) Inventors: Chunda DING, Beijing (CN); Xiaocheng HUANG, Singapore (SG); Minbo QIU, Beijing (CN); Tenindra Nadeeshan ABEYWICKRAMA, Singapore (SG); Chen LIANG, Singapore (SG)

(21) Appl. No.: 18/561,112

(22) PCT Filed: Jun. 27, 2022
(86) PCT No.: PCT/SG2022/050440

§ 371 Date: Nov. 15, 2023

(30) Foreign Application Priority Data
Jun. 30, 2021 (CN) 202110748355.9

(51) Int. Cl. H04W 12/64; G01C 21/32; G01C 21/34; G06F 16/29

(52) U.S. Cl. CPC H04W 12/64; G01C 21/32; G01C 21/3476; G06F 16/29

(57) ABSTRACT

A computer implemented method of annotating map data, in particular for navigation of vehicles, the method including: receiving the map data including a graph of a road network including a plurality of vertices and edges; pre-processing the graph to produce a planar graph including a plurality of polygons; grouping the plurality of polygons to form a plurality of geofences, each of the plurality of geofences including a number of POIs which may be within a pre-determined POI range, and each of the plurality of geofences having a road traversal length that may be within a pre-determined length range; storing geofence data of the plurality of geofences in a memory of a computer; and annotating each of the plurality of geofences.

### TECHNICAL FIELD

An aspect of the disclosure relates to a computer implemented method for annotating map data for navigation of vehicles.

### BACKGROUND

There are drawbacks in traditional grid-based task division of geo-annotation. The boundary of a grid may cut a highway halfway where the highway exit is outside of the grid. Firstly, it is challenging to human collectors to find a way back to the grid. Secondly, it leads to duplicate collection since a same road is traversed by collectors of two different grids. Accordingly, there is a need for providing improved geofences and for methods for providing improved geofences.

### SUMMARY

An aspect of the disclosure relates to a computer implemented method for preparing map data for annotation, in particular for navigation of vehicles, the method including:
receiving the map data including a graph of a road network including a plurality of vertices and edges;
pre-processing the graph to produce a planar graph including a plurality of polygons;
grouping the plurality of polygons to form a plurality of geofences, each of the plurality of geofences including a number of POIs which may be within a pre-determined POI range, and each of the plurality of geofences having a road traversal length that may be within a pre-determined length range; and storing geofence data of the plurality of geofences in a memory of a computer. The computer implemented method may be carried out by a computer system, e.g., a computer, comprising one or more microprocessors.

In some embodiments, the method is a method of annotating map data, further including annotating each of the plurality of geofences, for example, including determining points of interests (POIs) in the graph.

In some embodiments, the annotated map data may be used in vehicle navigation.

In some embodiments, the annotated map data may be stored in a memory (e.g., a data carrier) including the annotated map data.

According to various embodiments, the pre-processing the graph may include mapping each of the plurality of vertices onto a point with individual coordinate on a 2-D plane, e.g., by a microprocessor.

According to various embodiments, the pre-processing the graph may further include mapping an overpass in the graph to a virtual intersection point on the 2-D plane, e.g., by a microprocessor.

According to various embodiments, the pre-processing the graph may further include mapping each of the plurality of edges without the overpass to an edge on the 2-D plane, e.g., by a microprocessor.

According to various embodiments, the pre-processing the graph may further include mapping each of the plurality of edges with the overpass to multiple edges on the 2-D plane split, the multiple edges being split by the virtual intersection point, e.g., by a microprocessor.

According to various embodiments, the plurality of geofences may be non-overlapping.

According to various embodiments, the grouping the plurality of polygons may include generating a set of closed paths by traversing all edges of the plurality of polygons from both directions, e.g., by a microprocessor.

According to various embodiments, the grouping the plurality of polygons may further include filtering the set of closed paths to obtain simple cycles by discarding all interior vertices and edges interior to the set of closed paths, e.g., by a microprocessor.

According to various embodiments, the grouping the plurality of polygons may further include merging a plurality of selected simple cycles with their neighbor so that the plurality of geofences may be obtained, e.g., by a microprocessor.

According to various embodiments, the generating the set of closed paths may include:
pre-calculating a leftmost turn of each direction of each of the edges as a next edge;
starting traversing at each of the edges in each direction;
traversing the edge and the next edge until returning to the starting edge in the direction, wherein a u-turn may be made only if there may be no other turns, wherein the traversed edges and vertices thereof form the set of closed paths.

According to various embodiments, the filtering the set of closed paths may include: traversing an edge which may be leftmost in each of the set of closed paths;
continuing traversing the next edge until returning to the starting edge, wherein each duplicated vertex, which leads to more than one edges, may be skipped, wherein the traversed edges and vertices thereof form the simple cycles.

According to various embodiments, the merging the plurality of selected simple cycles with their neighbor may include for each of the plurality of selected simple cycles, which has a smaller number of POIs than the plurality of geofences, choosing a neighbor to merge with so that the plurality of geofences may be generated.

According to various embodiments, a greedy search algorithm may be used to choose the neighbor so that the generated plurality of geofences having a road traversal length may be within the pre-determined length range.

According to various embodiments, a cycle with a longest common edge may be chosen as a neighbor.

According to various embodiments, the computer implemented method may further include:
distributing the plurality of the geofences to a plurality of computing units;
annotating by processing the geofence data of the plurality of geofences by the plurality of computing units in parallel; and
consolidating results of the processing in the memory of the computer.

According to various embodiments, the computer implemented method may further include:
calculating a vehicle route between a first POI and a second POI of the POIs; and
routing the vehicle along the vehicle route.

An aspect of the disclosure relates to a computer program product including program instructions, which when executed by one or more micoprocessors, cause the one or more microprocessors to perform the method.

### BRIEF DESCRIPTION OF THE DRAWINGS

The disclosure will be better understood with reference to the detailed description when considered in conjunction with the non-limiting examples and the accompanying drawings, in which:

FIG. 1 shows an exemplary flowchart of a method of annotating map data for navigation of vehicles in accordance with various embodiments;

FIG. 2 shows an exemplary illustration of a computer 20 for implementing the method in accordance with various embodiments;

FIG. 3 shows a graph representation of a map data of a road network 30, including a plurality of vertices A′, B′, C′, D′, E′, F′ and edges A′-B′, C′-D′, E′-F′, wherein a trunk road goes over two motorways;

FIG. 4 shows an exemplary illustration of merging a plurality of selected simple cycles 41 with their neighbor to form a plurality of geofences 42;

FIG. 5 shows an exemplary flowchart of a method of generating the set of closed paths in accordance with various embodiments;

FIGS. 6A to 6C illustrates an example of the method in accordance with various embodiments being implemented on a simple graph;

FIGS. 7A and 7B show an exemplary illustration of two examples of merging selected simple cycles with their neighbor so that geofences may be generated;

FIG. 8 shows the task distribution of each geofence.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the methods are analogously valid for the other methods.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

As used herein and in accordance to various embodiments, the map data including a graph may mean that the map data includes, but is not limited to, imagery, latitude and longitude coordinates, points of interest and traffic data of a road network which may be represented in the form of a graph including a plurality of vertices and edges. An exemplary data storage format may be (vertex 1, vertex 2, latitude, longitude, traffic direction, {List of POIs in edge}), wherein the edge may be between vertex 1 and vertex 2.

As used herein and in accordance with various embodiments, annotating map data may include annotating each of the plurality of geofences, for example, including determining points of interests (POIs) in the graph.

As used herein and in accordance with various embodiments, navigation of vehicles may, for example, include one or more of: solving a route from a start point to a destination point, e.g., by a server; displaying a route and/or navigation directions on a driver's mobile device; displaying a route and/or navigation directions on a vehicle integrated navigation system.

As used herein and in accordance with various embodiments, receiving the map data may mean receiving by a communication interface of the computer, map data, e.g., from another computer, server, or cloud.

As used herein and in accordance with various embodiments, annotating each of the plurality of geofences, may mean determining points of interests in the graph. Annotating may mean processing the geofence data of the plurality of geofences by the plurality of computing units in parallel (e.g., by searching on other databases and matching location and/or by machine learning) or processing by humans in parallel. As used herein and in accordance with various embodiments, determining points of interests may mean completing POI information in the map data, for example, giving latitude and longitude, includingF label, road name, and house number. For example, to a given POI1=(lat, long) adding McBurger, number 48, Main road, as (lat, long, McBurger, 48, Main road).

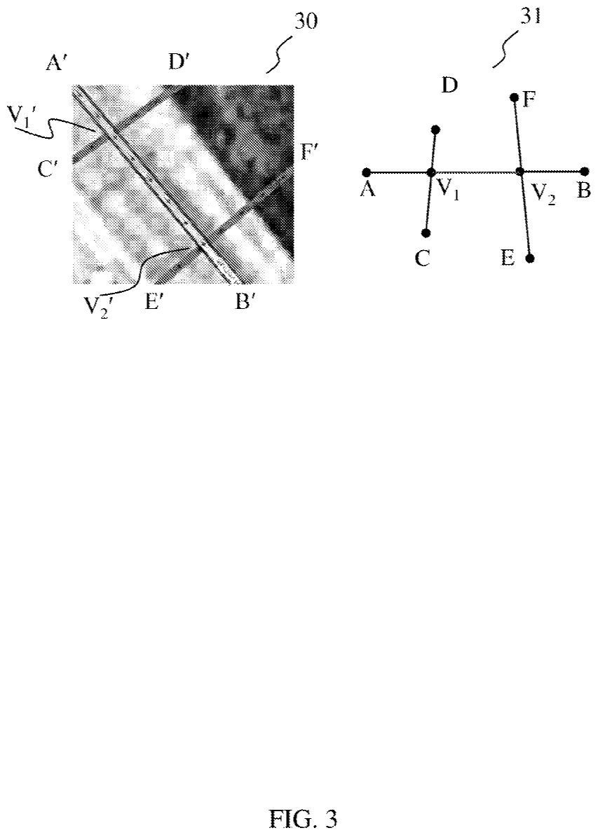

As used herein and in accordance with various embodiments, a polygon may mean a closed polygonal chain (or polygonal circuit) formed by connecting a finite number of straight line segments. The segments of a polygonal circuit may be called its edges. The points where two edges meet may be called the polygon's vertices. The polygon may also mean a closed circuit which has a zero area. For example, in FIG. 3, AV₁->V₁D->DV₁->V₁V₂->V₂F->FV₂->V₂B->BV₂->V₂E->EV₂->V₂V₁->V₁C->CV₁->V₁A forms a closed circuit with a zero area.

The method of the disclosure includes a two-phase approach to first split the road network to generate a set of closed paths, filter (e.g., trim) a set of closed paths to obtain a set of small simple cycles and then merge some of the simple cycles to achieve higher efficiency.

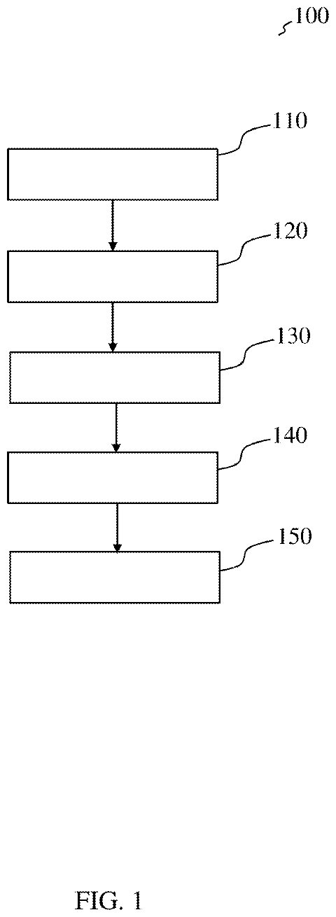

FIG. 1 shows an exemplary flowchart in accordance with various embodiments, which will be used as illustration in below description, that, however, is not limited to the drawings. According to various embodiments, a computer implemented method 100 of annotating map data, in particular for navigation of vehicles 10 includes receiving 110 the map data. The map data includes a graph of a road network 30 (see FIG. 3) including a plurality of vertices A′, B′, C′, D′, E′, F′ and edges A′-B′, C′-D′, E′-F′. The graph of a road network 30 may also include overpass areas where one road passes over another but does not intersect, which may be indicated herein by virtual vertices. As shown in FIG. 3, a trunk road goes over two motorways.

According to various embodiments, the computer implemented method 100 may include a step 120 of pre-processing the graph to produce a planar graph including a plurality of polygons 31 (see FIG. 3). In other words, the pre-processing includes a planarization step. Each part of a road in the graph may belong to a unique polygon in the planar graph.

According to various embodiments, the computer implemented method 100 may include a step 130 of grouping the plurality of polygons 31 to form a plurality of geofences 42, each of the plurality of geofences including a number of POIs which may be within a pre-determined POI range, and each of the plurality of geofences 42 having a road traversal length that may be within a pre-determined length range. For example, a pre-determined POI range may be selected from the range of from 500 to 2000. For example, a pre-determined length range may be selected from the range of from 2 km to 10 km.

In some embodiments, the road traversal length may be a haversine distance between vertices of roads. A bidirectional road may be counted twice.

In some embodiments, the pre-determined length range may be a minimal road traversal length to travel all roads in a tour where all the roads are in the plurality of geofences. Avoiding too small geofences also avoids cutting roads into half thereby improving efficiency of data collection. Avoiding too large geofences may ensure the data collection will be completed within a specified time. Providing equally size the geofences, in other words, geofences with an inter-geofence variation of minimal road traversal length below a pre-determined percentage assist enables an equalized distribution of work load for parallel processing of each geofence.

According to various embodiments, the computer implemented method 100 may include a step 140 of storing geofence data of the plurality of geofences 42 in a memory 21 of a computer 20. Storing may include a microprocessor sending instructions to a memory to save the geofence data into the memory. In examples, in accordance with various embodiments, the memory may be RAM, solid state drive such as NAND or NOR FLASH, magnetic recording media, HDD, optical recording media such as DVD, etc.

According to various embodiments, the computer implemented method 100 may include a step 150 of annotating each of the plurality of geofences 42.

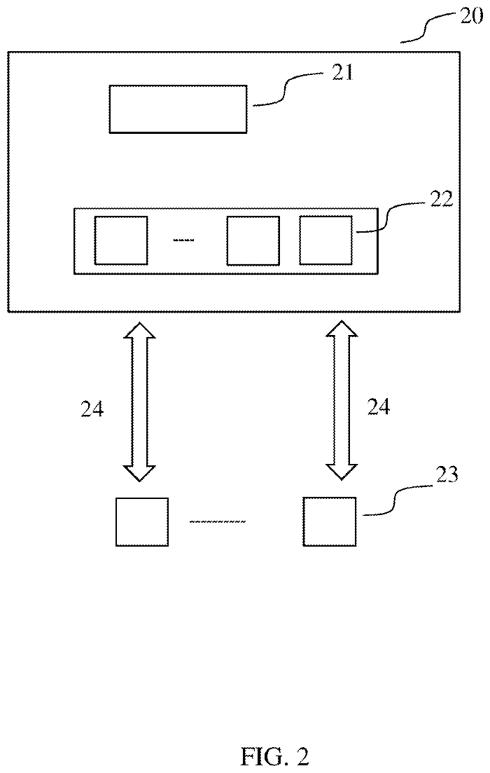

FIG. 2 shows an exemplary illustration of a computer 20 for implementing the method. The computer 20 may comprise a memory 21 for storing geofence data of the plurality of geofences 42, and one or more microprocessors 23 for processing geofence data of the plurality of geofences 42. The computer 20 may communicate with a plurality of computing units 22 via one or more communication interfaces 24.

FIG. 3 shows an exemplary illustration of pre-processing 120 the graph to produce a planar graph including a plurality of polygons 31 according to various embodiments.

According to various embodiments, as illustrated in FIG. 3, the pre-processing 120 the graph may include mapping each of the plurality of vertices onto a vertex A, B, C, D, E, F with individual coordinate on a 2-D plane.

According to various embodiments, the pre-processing 120 the graph may further include mapping an overpass V₁′, V₂′ in the graph to a virtual intersection points A, B, C, D. E, F) on the 2-D plane.

According to various embodiments, the pre-processing 120 the graph may further include mapping each of the plurality of edges without the overpass V₁′, V₂′ to an edge on the 2-D plane. To index all the edges in the graph, RTree may be used. All the roads are numbered. The roads are grouped by their number as the RTree leaf. Bounding-box is obtained for each leaf. Edges within a leaf or two intersected leaves may be cross-checked since rectangle bounding boxes of two disjoint leaves are guaranteed not to intersect with each other. In one embodiment, all the vertices may have individual coordinates.

According to various embodiments, the pre-processing 120 the graph may further include mapping each of the plurality of edges with the overpass V₁′, V₂′ to multiple edges on the 2-D plane split, the multiple edges being split by the virtual intersection points V₁, V₂. As illustrated in FIG. 3, the virtual intersection points V₁, V₂ split the edge AB in the graph into multiple edges AV₁. V₁V₂. V₂B on the 2-D plane. The planar graph may be an undirected connected graph where either direction of an edge is allowed.

According to various embodiments, mapping may be performed by a microprocessor, e.g., executing instructions for mapping.

According to various embodiments, the plurality of geofences 42 may be non-overlapping.

According to various embodiments, the grouping 130 the plurality of polygons 31 may include generating a set of closed paths by traversing all edges of the plurality of polygons 31 from both directions.

According to various embodiments, the grouping 130 the plurality of polygons 31 may further include filtering the set of closed paths to obtain simple cycles 41 by discarding all interior vertices and edges interior to the set of closed paths.

According to various embodiments, the grouping 130 the plurality of polygons 31 may further include merging a plurality of selected simple cycles 41 with their neighbor so that the plurality of geofences 42 may be obtained.

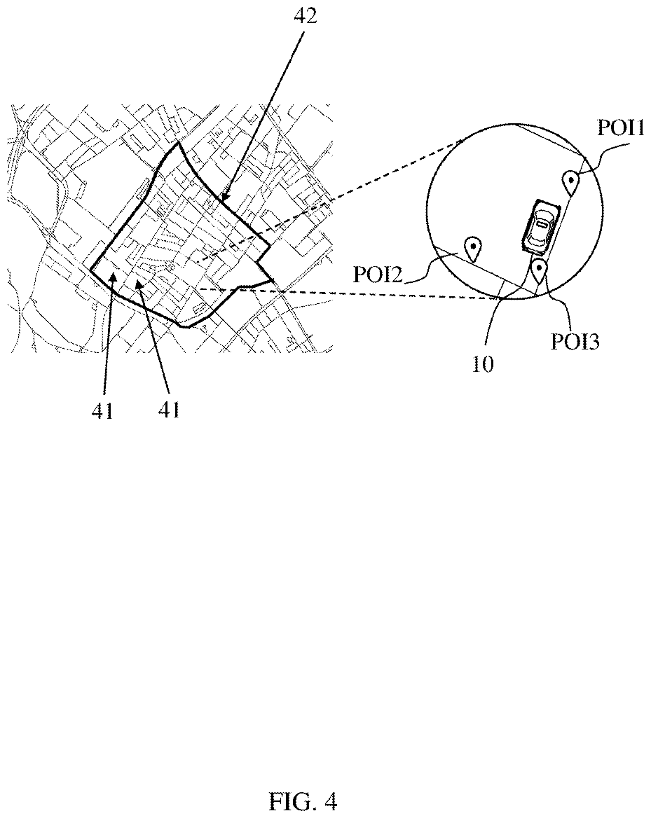

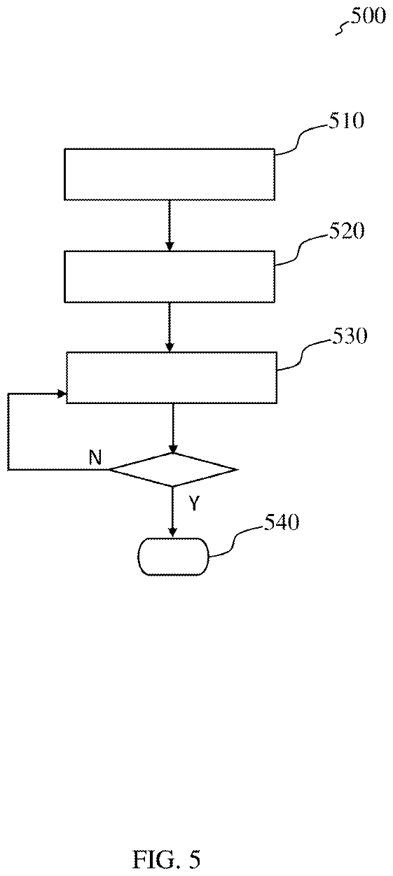

FIG. 4 shows an exemplary resulting geofence 42 obtained with the method in accordance with various embodiments, by merging a plurality of selected simple cycles 41 with their neighbors, wherein a portion of the resulting geofence 42 is magnified to illustrate POIs POI1, POI2 and POI3, and an overlaid representation of a vehicle 10, for illustration purposes. FIG. 5 shows an exemplary illustration of generating the set of closed paths;

According to various embodiments, the generating the set of closed paths may include pre-calculating 510 a leftmost turn of each direction of each of the edges as a next edge. Alternatively, the generating the set of closed paths may include pre-calculating 510 a rightmost turn of each direction of each of the edges as a next edge.

According to various embodiments, the generating the set of closed paths may include starting 520 traversing at each of the edges in each direction.

According to various embodiments, the generating the set of closed paths may include traversing 530 the edge and the next edge until returning 540 to the starting edge in the direction, wherein a u-turn may be made only if there may be no other turns, wherein the traversed edges and vertices thereof form the set of closed paths.

In some embodiments, a closed path ϕ may be denoted by a vertex sequence={p₀, p₁, p₂, p₃ . . . . pₙ} where ∀i ∈ [0, n], (pi, p₍ᵢ₊₁₎mod n) is an edge in a planar graph. A set of closed paths Φ may be generated by repeating traversing all edges of a plurality of polygons in the planar graph from both directions. The set of closed paths ϕ may cover all the edges with both directions in the planar graph. Since an edge (p₀→p₁) in the planar graph is undirected, (p₀→p₁) and (p₁→p₀) may be used to represent the respective directions, therefore the set of closed paths Φ may be represented as an edge sequence Φ={(p₀→p₁), (p₁→p₂) . . . (pₙ→p₀)}. For example, a next edge of each edge (e.g., (p₀=p₁)) may be pre-calculated by making a leftmost turn at p₁. Then the traversal may start at each direction of each edge (p₀→p₁), and make a leftmost turn at the intersection p₁. The traversal continues e.g., for (p₁→p₂), (p₂→p₃) . . . until returning to the starting edge (p₀→p₁).

In some embodiments, two closed paths among the set of closed paths may be adjacent or disjoint, i.e. not intersecting, or containing each other.

In some embodiments, two closed paths among the set of closed paths may be adjacent and share edges in different directions, i.e. have common edges.

In some embodiments, two closed paths among the set of closed paths may be identical.

According to various embodiments, the filtering the set of closed paths may include traversing an edge which may be leftmost in each of the set of closed paths.

According to various embodiments, the filtering the set of closed paths may include continuing traversing the next edge until returning to the starting edge, wherein each duplicated vertex, which leads to more than one edges, may be skipped, wherein the traversed edges and vertices thereof form the simple cycles.

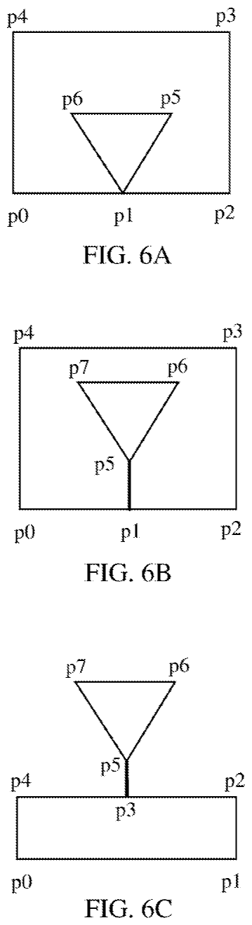

FIGS. 6A, 6B and 6C show an exemplary illustration of three examples of closed paths respectively. As illustrated, the closed paths in FIGS. 6A and 6B both have common vertices p₁ respectively. The closed paths in FIG. 6B have directional edges (p₁→p₅) and (p₅→p₁) sharing a common edge. Take the closed paths in FIG. 6A as an example, (p₀→p₁) may be first selected as starting edge, since p₁ is a duplicated vertex, another following edge (p₁→p₂) ending with p₁ may be selected, then (p₁→p₂) is traversed and (p₁→p₆), (p₆→p₅) and (p₅→p₁) are skipped and traversal is continued for (p₂→p₃), (p₃→p₄), (p₄→p₀) and finally come back to (p₀→p₁) to form the boundary. The traversed edges and vertices thereof form the simple cycles. In some embodiments, a starting edge, where a starting vertex of which is leftmost in the closed path, may be selected as the starting edge so as to ensure the generated simple cycle forms the boundary. The biggest closed path in FIG. 6C, where there is no bounded interior area, may be discarded.

According to various embodiments, the merging the plurality of selected simple cycles with their neighbor may include for each of the plurality of selected simple cycles, which has a smaller number of POIs than the plurality of geofences 42, choosing a neighbor to merge with so that the plurality of geofences 42 may be generated.

In some embodiments, a plurality of selected simple cycles may be defined as Φ={ϕᵢ}, a set of roads belonging to one of the plurality of selected simple cycles may be defined as e (ϕᵢ), the total road distance of e(ϕᵢ) may be defined as s(ϕᵢ) and the road traversal distance to travel all the roads in a tour where the roads are in ϕᵢ may be defined as T(ϕᵢ).

In some embodiments, given a simple cycle ϕᵢ, an efficiency of the simple cycle may be represented as the road traversal length of e(ϕᵢ) divided by the road traversal distance of ϕᵢ:

$${E}_{t} ( Φ ) = {\sum }_{{ϕ}_{i} ϵΦ} s ( {ϕ}_{i} ) / \sum T ( {ϕ}_{i} )$$

In some embodiments, the optimized efficiency of the simple cycle may be represented as Argmax_{Φ}(Eₜ(Φ)). Since Σ s(ϕᵢ) may equal to the total road distance in the road network, and therefore may be a constant, optimizing the efficiency of the simple cycle may be equivalent to minimizing the road traversal distance:

$$Arg {min}_{Φ} ( {\sum }_{{ϕ}_{i} ϵΦ} T ( {ϕ}_{i} ) )$$

In some embodiments, given two adjacent simple cycles ϕ₁ and ϕ₂ with at least one common edge, the geofence ϕ₃ is such that
all directed edges in ϕ₃ belong to either ϕ₁ or ϕ₂
ϕ₃ is also simply
all directed edges in ϕ₁ and ϕ₂ are either part of the boundary of ϕ₃ or contained within ϕ₃.

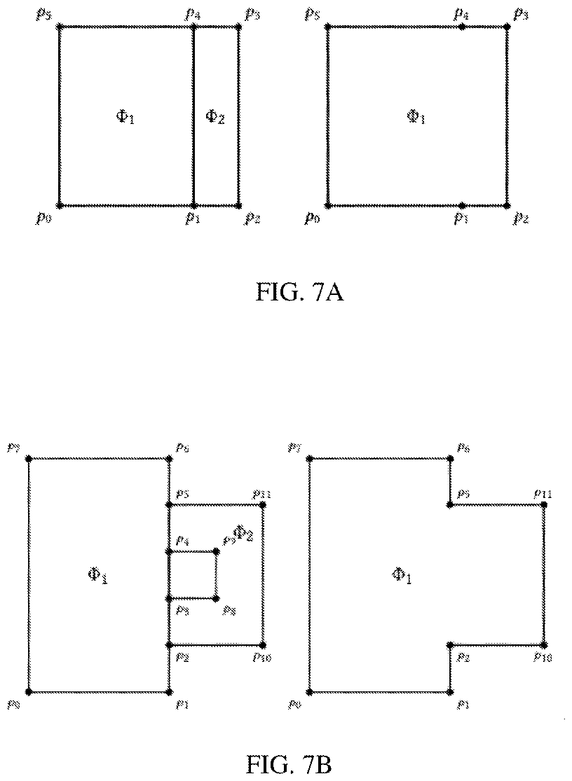

FIGS. 7A and 7B show an exemplary illustration of two examples of merging selected simple cycles with their neighbor so that geofences may be generated.

In some embodiments, the simplest case of merging two simple cycles is to remove the common edges. As shown in FIG. 7A, merging ϕ₁={p₀, p₁, p₄, p₅} and ϕ₂={p₁, p₂, p₃, p₄} results in ϕ₃={p₀, p₁, p₂, p₃, p₄, p₅}.

However, as shown in FIG. 7B, merging ϕ₁={p₀, p₁, p₂, p₃, p₄, p₅, p₆, p₇} and ϕ₂={p₂,p₁₀, p₁₁, p₅, p₄, p₉, p₈, p₃} results in ϕ₃={p₀, p₁, p₂, p₁₀, p₁₁, p₅, p₆, p₇} where an interior closed path {p₄, p₉, p₈, p₃} is absorbed.

In some exemplary embodiments of merging two simple cycles, a traversal goes along one simple cycle, and always switches to the other simple cycle at intersections. In FIG. 7A, starting with (p₀→p₁) ∈ ϕ₁, the traversal switches to (p₁→p₂). At intersection p₂, the traversal switches to (p₂→p₁₀) ∈ ϕ₂. After (p₁₀→p₁₁), (p₁₁→p₅), the traversal switches to (p₅→p₆). After (p₆→p₇), (p₇→p₀), the traversal returns to (p₀→p₁). The directed edges traversed form the geofence. However, if the traversal starts with (p₃→p₄), the traversal ends up with (p₄→p₉), (p₉→p₈), (p₈→p₃), (p₃→p₄), i.e. the interior closed path. Therefore, the starting edge is chosen to be an edge that will be in the geofence. Clearly, the four edges at the corner must be in the geofence if they are not common edges.

In some embodiments, a starting edge e, may be chosen and the traversal starts with the current edge being e₀={k₀→k₁}. If k₁ is an intersection vertex, the traversal switches to the other simple cycle until returning to e₀. The directed edges traversed form the geofence.

According to various embodiments, a greedy search algorithm may be used to choose the neighbor so that the generated plurality of geofences 42 having a road traversal length may be within the pre-determined length range.

In some embodiments, the shape of the geofence may be considered to minimize its road traversal length, i.e. to minimize the longest Euclidean distance between any two vertices on the boundary of the simple cycle. This may be carried out by merging the given simple cycle with each of its neighbors and then choosing the neighbor resulting in a minimal road traversal length.

According to various embodiments, a cycle with a longest common edge may be chosen as a neighbor.

According to various embodiments, the computer implemented method 100 may further include distributing the plurality of the geofences 42 to a plurality of computing units 22.

According to various embodiments, the computer implemented method 100 may further include annotating 150 by processing the geofence data of the plurality of geofences 42 in parallel, for example, by the plurality of computing units 22.

According to various embodiments, the computer implemented method 100 may further include consolidating results of the processing in computer memory, e.g., in the memory 21 of the computer 20.

According to various embodiments, computer memory may mean a memory which is readable by a computer or its microprocessor, the memory may be integrated in a computer or may be a data carrier.

One aspect of the disclosure relates to a computer memory storing results of the annotation, for further use. The results of annotation may be map of a road network and/or POIs, name of roads, type of roads, number of lanes of roads, direction of each lane, name of POIs, house number of POIs.

According to various embodiments, the computer implemented method 100 may further include calculating a vehicle route between a first POI and a second POI of the POIs.

According to various embodiments, the computer implemented method 100 may further include routing the vehicle along the vehicle route.

According to various embodiments, a computer program product including program instructions, which when executed by one or more microprocessors, cause the one or more microprocessors to perform the method 100.

### Examples

The pseudo code in Algorithm 1 presents an exemplary algorithm of splitting the road network to generate a set of closed paths. A next edge of every (p₀→p₁) may be pre-calculated by making a leftmost turn at p₁, i.e. Next (p₀→p₁) (Line˜5). A traversal starts at each direction of each edge (p₀→p₁) (Line˜7), makes a leftmost turn at the intersection p₁ (Line˜11) and stops when returning to the initial edge (Line˜10).

Algorithm 1 Splitting Phase

| | |
|---|---|
| 1: | INPUT: G′ = (V′,E′) |
| 2: | OUTPUT: A set of circles Φ |
| 3: | {/}/Pre-calculate the left most turn of each direction of an edge |
| 4: | for each direction of each edge (p₀ → p₁) do |
| 5: | calculate Next(p₀ → p₁)) |
| 6: | end for |
| 7: | for each direction of each edge (p₀ → p₁) do |
| 8: | ϕ₀ ← e; add (p₀ → p₁) to ϕ₀ |
| 9: | e ← (p₀ → p₁) |
| 10: | while Next(e) ≠ (p₀ → p₁) do |
| 11: | e ← Next(e) |
| 12: | add e to ϕ₀ |
| 13: | end while |
| 14: | add ϕ₀ to Φ |
| 15: | end for |

The pseudo code in Algorithm 2 presents an exemplary algorithm of filtering (i.e., trimming) a set of closed paths to obtain a set of small simple cycles. A directed edge starting with vertex v may be denoted by ϕ(v). In the initialization, choose_initial_edge (ϕ₁) the starting edge e₀, where its starting vertex is left-most in ϕ₁, may be carefully selected to ensure that the result forms the boundary. Then the traversal may start with the current edge being e=(k₀→k₁). If k₀ is a duplicated vertex, it may be skipped and the traversal goes to the first edge starting with k₀ on the cycle through find_next_edge. Each time in iterating an edge is added into ϕ₂ until returning to e₀. ϕ₂ holds the results.

Algorithm 2 Trim

| | |
|---|---|
| 1: | INPUT: ϕ₁ |
| 2: | OUTPUT: ϕ₂ |
| 3: | Initialisation: |
| 4: | Denote by ϕ( [symbol] ) the directed edges in circle ϕ₁ starting with |
| | node [symbol] . |
| 5: | ϕ₂ ← e |
| 6: | e₀ ← choose_initial_edge(ϕ₁) |
| 7: | e = (k₀ → k₁) ← e₀ |
| 8: | while TRUE do |
| 9: | if exits another e′ ∈ ϕ(k₀) and e′ ≠ e then |
| 10: | // k₀ is duplicated |
| 11: | e ← find_next_edge(e, k₀) |
| 12: | continue |
| 13: | end if |
| 14: | add e to ϕ₂ |
| 15: | e ← then |
| 16: | if e == e₀ then |
| | break |
| 17: | end if |
| 18: | end while |
| 19: | return ϕ₂ |

[symbol]

indicates data missing or illegible when filed

The pseudo code in Algorithm 3 presents an exemplary algorithm of merging two simple cycles. Assuming circle i represents a simple cycle, the directed edge in circle i starting with vertex v may be denoted by ϕ(v,i). In the initialization phase, in choose_initial_edge (ϕ₁,ϕ₂) the starting edge e₀ (Line˜5) may be calculated. The traversal may start with the current edge being e₀={k₀→k₁}. If k₁ is an intersection vertex (Line˜10), the traversal switches to the other circle (Line˜12) until returning to e₀ (Line˜15). ϕ₃ holds the results.

Algorithm 3 Merging Two Circles

| | |
|---|---|
| 1: | INPUT: ϕ₁ |
| 2: | OUTPUT: ϕ |
| 3: | Initialisation: |
| 4: | Denote by ϕ( [symbol] , [symbol] ) the directed edges in circle [symbol] starting with node |
| | [symbol] . |
| 5: | ϕ₃ ← [symbol] |
| 6: | e₀ ← choose_initial_edge(ϕ₁, ϕ₂) |
| 7: | e = (k₀ → k₁) → e₀ |
| 8: | while TRUE do |
| 9: | add e to ϕ₃ |
| 10: | next_circle_id ← id(e) |
| 11: | if ϕ(k₁, id(ϕ₁)) ≠ [symbol] and ϕ(k₁, id(ϕ₂)) ≠ [symbol] then |
| 12: | // k₁ is an intersection node |
| 13: | next_circle_id ← id(e) == id(ϕ₁)?id(ϕ₂) [symbol] id(ϕ₁) |
| 14: | end if |
| 15: | e → ϕ(k₁, next_circle_id) |
| 16: | if e == e₀ then |
| | break |
| 17: | end if |
| 18: | end while |
| 19: | return ϕ₃ |

[symbol]

indicates data missing or illegible when filed

The pseudo code in Algorithm 4 presents an exemplary algorithm of merging phase to merge a set of simple cycles. To optimize the efficiency, for example, the neighbor with the maximal length of the common edges may be chosen.

Algorithm 4 Merging Phase

| | |
|---|---|
| 1: | INPUT: A set of circles Φ |
| 2: | return A set of merged circles Φ′ |
| 3: | while Φ ≠ [symbol] do |
| 4: | ϕₘᵢₙ ← pop_min_circle(Φ) |
| 5: | ϕ_{neighbor} ← find_best_neighbor(Φ, ϕₘᵢₙ) |
| 6: | if s(ϕₘᵢₙ) + s(ϕ_{neighbor}) > upperbound then |
| 7: | add ϕₘᵢₙ to Φ′ // output |
| 8: | continue |
| 9: | end if |
| 10: | ϕ_{new} ← merge_two_circles(ϕₘᵢₙ, ϕ_{neighbor}) |
| 11: | add ϕ_{new} to Φ // continue to be merged |
| 12: | end while |

[symbol]

indicates data missing or illegible when filed

Given map data comprising a graph of a road network, the disclosure is targeted to produce a plurality of non-overlapping geofences, each of the plurality of geofences comprising a number of POIs which is within a pre-determined POI range, and each of the plurality of geofences having a road traversal length that is within a pre-determined length range.

The disclosure takes into account the tradeoff between the number of tasks (number of geofences), efficiency of tasks (size of geofences and inter-geofence size variation). In particular, the method is advantageously used to generate relatively enough geofences which reduce the risk of cutting roads into half thereby improving efficiency of tasks, while at the same time to avoiding too large geofences and too much inter-geofence size variation. Therefore, the method optimizes the balance of the number of tasks and the efficiency of tasks thereby improving overall computing system efficiency and usage time.

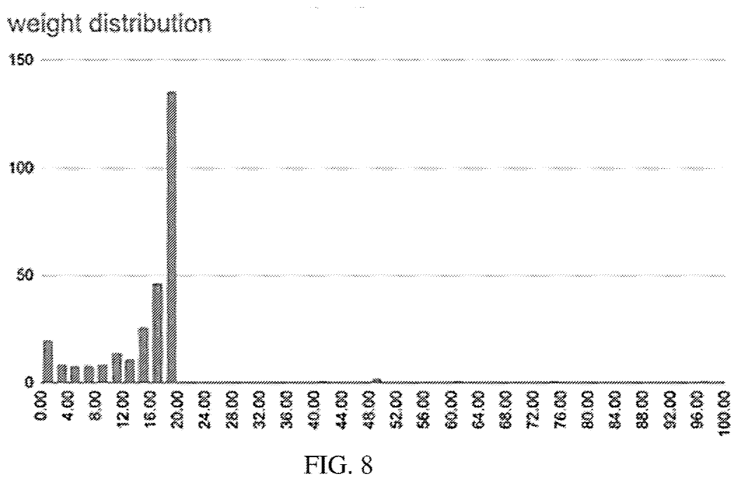

FIG. 8 shows the task distribution of each geofence. It can be seen that most geofences have a similar size (10˜20 km). The X-axis denotes the task size of geofences, the y-axis denotes the number of geofences.

While the disclosure has been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

1. A computer implemented method for annotating map data for navigation of vehicles, the method comprising:
receiving the map data comprising a graph of a road network comprising a plurality of vertices (A′, B′, V′, D′, E′, F) and edges A′, B′, C′-D′, E′-F′);
pre-processing the graph to produce a planar graph comprising a plurality of polygons:
grouping the plurality of polygons to form a plurality of geofences, each of the plurality of geofences comprising a number of point of interests which is within a pre-determined POI range, and each of the plurality of geofences having a road traversal length that is within a pre-determined length range:
storing geofence data of the plurality of geofences in a memory of a computer; and
annotating each of the plurality of geofences.

2. The computer implemented method of claim 1, wherein the pre-processing the graph further comprises:
mapping each of the plurality of vertices onto a point (A, B, C, D, E, F) with individual coordinate on a 2-D plane.

3. The computer implemented method of claim 2, wherein the pre-processing the graph further comprises:
mapping an overpass (V1′, V2′) in the graph to a virtual intersection point (V1, V2) on the 2-D plane.

4. The computer implemented method of claim 3, wherein the pre-processing the graph further comprises:
mapping each of the plurality of edges without the overpass (V1′, V2′) to an edge on the 2-D plane.

5. The computer implemented method of claim 3, wherein the pre-processing the graph further comprises:
mapping each of the plurality of edges with the overpass (V1′, V2′) to multiple edges on the 2-D plane split, the multiple edges being split by the virtual intersection point (V1, V2).

6. The computer implemented method of claim 1, wherein the plurality of geofences (42) are non-overlapping.

7. The computer implemented method of claim 1, wherein the grouping the plurality of polygons further comprises:
generating a set of closed paths by traversing all edges of the plurality of polygons from both directions.

8. The computer implemented method of claim 7, wherein the grouping the plurality of polygons further comprises:
filtering the set of closed paths to obtain simple cycles by discarding all interior vertices and edges interior to the set of closed paths.

9. The computer implemented method of claim 8, wherein the grouping the plurality of polygons further comprises:
merging a plurality of selected simple cycles with their neighbor so that the plurality of geofences are obtained.

10. The computer implemented method of claim 1, wherein the generating the set of closed paths further comprises:
pre-calculating a leftmost turn of each direction of each of the edges as a next edge: starting traversing at each of the edges in each direction;
traversing the edge and the next edge until returning to the starting edge in the direction, wherein a u-turn is made only if there are no other turns, wherein the traversed edges and vertices thereof form the set of closed paths.

11. The computer implemented method of claim 8, wherein the filtering the set of closed paths further comprises:
traversing an edge which is leftmost in each of the set of closed paths:
continuing traversing the next edge until returning to the starting edge, wherein each duplicated vertex, which leads to more than one edges, is skipped, wherein the traversed edges and vertices thereof form the simple cycles.

12. The computer implemented method of claim 9, wherein the merging the plurality of selected simple cycles with their neighbor further comprises:
for each of the plurality of selected simple cycles, which has a smaller number of POIs than the plurality of geofences, choosing a neighbor to merge with so that the plurality of geofences are generated.

13. The computer implemented method of claim 12, wherein a greedy search algorithm is used to choose the neighbor so that the generated plurality of geofences having a road traversal length is within the pre-determined length range.

14. The computer implemented method of claim 12, wherein a cycle with a longest common edge is chosen as a neighbor.

15. The computer implemented method of claim 1, further comprising:
distributing the plurality of the geofences to a plurality of computing units: annotating by processing the geofence data of the plurality of geofences by the plurality of computing units in parallel; and
consolidating results of the processing in the memory of the computer.

16. The computer implemented method of claim 1, further comprising:
calculating a vehicle route between a first POI and a second POI of the POIs; and
routing the vehicle along the vehicle route.

17. A computer program product comprising program instructions, which when executed by one or more microprocessors, cause the one or more microprocessors to perform a method for annotating map data for navigation of vehicles, the method comprising:
receiving the map data comprising a graph of a road network comprising a plurality of vertices (A′, B′, C′, D′, E′, F) and edges (A′-B′, C′-D′, E′-F′);
pre-processing the graph to produce a planar graph comprising a plurality of polygons;
grouping the plurality of polygons to form a plurality of geofences, each of the plurality of geofences comprising a number of point of interests which is within a pre-determined POI range, and each of the plurality of geofences having a road traversal length that is within a pre-determined length range:
storing geofence data of the plurality of geofences in a memory of a computer; and
annotating each of the plurality of geofences.
